(19) United States
(12) Patent Application Publication
(10) Pub. No.: US 2002/0161253 A1
(43) Pub. Date: Oct. 31, 2002

(54) Synthesis of bis (cyclopentadienyl) and bis (indenyl) ruthenium complexes

(75) Inventors: Karin A. Voll, Boulder, CO (US); Jeffrey M. Sullivan, Loveland, CO (US); Dawn A. Arkin, Longmont, CO (US); Fredric R. Askham, Loveland, CO (US)

Correspondence Address: EDWARD S. IRONS, 3945 - 52ND STREET, N.W., WASHINGTON, DC, 20016, US

(73) Assignee: Boulder Scientific Company

(21) Appl. No.: 09/938,952

(22) Filed: Aug. 24, 2001

Related U.S. Application Data
(63) Continuation-in-part of application No. 09/845,627, filed on Apr. 30, 2001, now abandoned.

(51) Int. Cl. C07F 17/02

(52) U.S. Cl. 556/143

(57) ABSTRACT

A process for preparing a cyclopentadienyl or indenyl ruthenium complex by treatment of a cyclopentadienyl or indenyl compound with ruthenium trichloride trihydrate and magnesium powder in an alkanol at 0° C. to −30° C. is described.

This application is a continuation-in-part of U.S. application Ser. No. 09/845,627 filed Apr. 30, 2001.

### FIELD OF THE INVENTION

This invention relates to bis(cyclopentadienyl) and bis(indenyl) ruthenium complexes which are useful in chemical vapor deposition (CVD) procedures.

### BACKGROUND OF THE INVENTION

The state of the art relevant to this invention as of Jul. 17, 1997 is summarized in U.S. Pat. No. 6,002,036. A process for the synthesis of bis(alkylcyclopentadienyl) ruthenium complexes by treatment of RuCl₃ hydrates and ethylcyclopentadiene or isopropylcyclopentadiene with zinc powder in an alcohol solvent at −30° C. to 0° C. is described.

### SUMMARY OF THE INVENTION

The invention comprises synthesis of bis(alkylcyclopentadienyl) ruthenium complexes by treating ruthenium trichloride hydrate and a cyclopentadienyl compound or an indenyl compound with magnesium powder in C₂ to C₈ alkanol, preferably ethanol, at a temperature of −30° C. to 0° C.

A product of 99% purity may be isolated in yields of at least 65% by crystallization from an alkane.

### DEFINITIONS

As used in this specification, the following terms have the meaning set forth:

(1) Cyclopentadienyl Compound—A compound of the formula

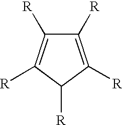

in which each R is independently hydrogen or a C₁ to C₁₀ alkyl group. Monoalkyl, preferably C₁ to C₅ monoalkyl, cyclopentadienyl compounds are preferred.

(2) Indenyl Compound—A compound of formula

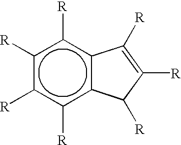

in which each R is independently hydrogen or a C₁ to C₁₀ alkyl group. Monoalkyl indenyl compounds are preferred.

### DETAILED DESCRIPTION OF THE INVENTION

Ruthenium trichloride dihydrate and a cyclopentadienyl compound or an indenyl compound and an alkanol, preferably ethanol, are combined and treated with magnesium powder, preferably 50 to 200 mesh, at low temperatures with an appropriate stir out. A bis(cyclopentadienyl) or bis(indenyl) ruthenecene may be isolated by filtration, followed by combination with an alkane solvent, preferably hexane, another filtration, and subsequent passage through a silica column. The final product may be isolated in >99% purity by crystallization from a C₂ to C₈ alkane solvent. Alternatively, a high purity product may be isolated by fractional crystallization.

### EXAMPLE 1

Ruthenium trichloride dihydrate is dissolved in ethanol. The solution is cooled to −20° C. to −30° C., and 4.0 to 4.4 equivalents of ethylcyclopentadiene (EtCp) are added. Over the course of 1 hr to 1.5 hr, magnesium powder (100 mesh) (3.0 equivalents) is added, and maintaining a temperature of −10° C. to −30° C. The consequent reaction mixture is stirred out for about 19 hours at 10-15° C., or until gas chromatography analysis indicates that the reaction is complete. Thereafter, the reaction mixture is filtered, and the ethanol and unreacted ethyl cyclopentadiene are removed under vacuum. Hexane and 3.0 equivalents of Na₂SO₄ are added to the remaining slurry which is then stirred for 1-20 hrs. The solids are removed by filtration through Celite. The remaining yellow solution is distilled under vacuum to an oil. Hexane is added back to the oil, followed by a filtration through Celite® or silica. A final run through a silica column may be appropriate to remove any color bodies.

Hexane is stripped from the yellow solution so produced. Pentane is added to the residual oil, and the product, (EtCp)₂Ru, is crystallized at −30° C. After removal of the supernatant, the pentane is then pumped off under vacuum. More than one crystallization may be appropriate to enhance purity. The yellow oil can be isolated in >99% purity with yields of 65%. This synthesis is illustrated by equation 1:

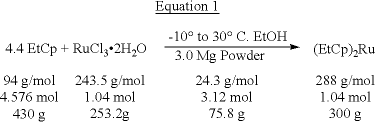

Any cyclopentadienyl or any indenyl compound as defined herein may be substituted for ethylcyclopentadiene in Example 1.

Magnesium powder of any desired mesh size, preferably 50 to 200 mesh, may be used. Any C₂ to C₈ alkanol may be used instead of ethanol.

### EXAMPLE 2

A magnesium slurry was produced by adding 45.62g of 100 mesh magnesium powder (made by READE) (1.88 moles) slowly to a 5 liter vessel containing 1.2L of ethanol (Filmex) at room temperature (25° C.). 323.00g of 76.8% pure cyclopentadiene (3.75 moles) at a temperature of about −50° C. was added to the magnesium slurry, which was at room temperature, through an addition funnel. To this, a 0.35M solution of RuCl₃*1.8H₂O in ethanol (Filmex) (0.625 moles in 1.8L of ethanol) was added over a 2.5 hour time period, via addition funnel, between −10° C. and 10° C. The slurry turned from a grey color to brown to green to blue, and then back to grey/brown with each addition of ruthenium trichloride. The mixture was then stirred at a temperature of from 5° C. to 10° C. for 3 hours, and was then stirred out to room temperature overnight. The ethanol was then distilled off under rough pump, and toluene was added back to remove all of the ethanol. When most of the ethanol was removed, the distillation was switched from rough pump to atomospheric pressure to prevent the product from foaming over into the receiver. When all of the ethanol was removed, the pot temperature was at 110° C. The yellow solution was hot filtered (100° C.) through a cake of Celite® that had been washed with hot toluene (100° C.). The filtrate was concentrated by distilling off the toluene to 650 ml, and the product crystallized out of the toluene solution as it cooled to room temperature. The yellow slurry was further cooled in a dry ice/acetone bath, and the light yellow crystalline solids were filtered onto a Buchner funnel, washed with 100 ml of hexane, and pumped dry giving 134.3 g of product (93% yield from first crop).

We claim:

1. A process for producing a cyclopentadienyl or an indenyl ruthenecene complex which comprises treating a cyclopentadienyl or an indenyl compound with ruthenium trichloride hydrate and magnesium powder.

2. The process of claim 1 wherein said treating of said cyclopentadienyl compound or said indenyl compound is accomplished in the presence of a C₂ to C₈ alkanol.

3. The process of claim 1 or claim 2 wherein said treating takes place at a temperature of 0° C. to −30° C.

4. The process of claim 2 wherein said alkanol is ethanol.

5. The process of claim 1 wherein the mesh size of said magnesium powder is from about 50 mesh to about 200 mesh.

6. The process which comprises:
(i) treating a C₂ to C₅ monoalkyl cyclopentadiene with ruthenium trichloride hydrate and magnesium powder,
wherein said treating is accomplished in the presence of ethanol and
wherein said treating takes place at a temperature of 0° C. and −30° C. to produce a first reaction mixture;
(ii) agitating said first reaction mixture at about 10° C. and 15° C. for a time period appropriate to complete the reaction
wherein a second reaction mixture comprising a slurry of C₂ to C₅ ruthenecene is produced;
(iii) filtering said second reaction mixture to provide a cake comprising a C₂ to C₅ ruthenecene; and
(iv) recrystallizing said C₂ to C₅ ruthenecene present in said cake
wherein a purified C₂ to C₅ ruthenecene product is obtained.

7. The process of claim 6 wherein said C₂ to C₅ monoalkyl cyclopentadiene of step (i) is ethyl cyclopentadiene and wherein said C₂ to C₅ ruthenecene of steps (ii), (iii) and (iv) is ethyl ruthenecene.
